(19) United States
(12) Patent Application Publication
(10) Pub. No.: US 2023/0045018 A1
(43) Pub. Date: Feb. 9, 2023

(54) SYSTEM AND PROCESS FOR PRINTING ON CYLINDRICAL OBJECTS

(71) Applicant: Acelorex, Inc., Penfield, NY (US)

(72) Inventors: Brendan Casey, Webster, NY (US); Michael Leo, Penfield, NY (US); George Gibson, Fairport, NY (US)

(73) Assignee: Acelorex, Inc., Penfield, NY (US)

(21) Appl. No.: 17/869,227

(22) Filed: Jul. 20, 2022

Related U.S. Application Data
(63) Continuation of application No. PCT/US2021/018652, filed on Feb. 19, 2021.
(60) Provisional application No. 62/980,192, filed on Feb. 22, 2020.

(51) Int. Cl. B41J 3/407; B41J 11/00; B41J 29/377

(52) U.S. Cl. CPC B41J 3/40733; B41J 3/40731; B41J 11/002; B41J 29/377

(57) ABSTRACT

A staged printing system includes: a printing station for printing an image upon an object; a curing station, operatively connected to the printing station, for curing the image printed upon the object; and a pretreatment station, operatively connected to the printing station, for pretreating the object before printing an image upon the object. The printing station includes a plurality of vertically mounted print heads for ejecting ink and a rotating platform for rotating the object as the plurality of vertically mounted print heads eject ink upon the object.

### PRIORITY INFORMATION

The present application is a continuation application of PCT Patent Application Number PCT/US2021/018652, filed on Feb. 19, 2021, and claims priority, under 35 U.S.C. §120, from PCT Patent Application Number PCT/US2021/018652, filed on Feb. 19, 2021. The entire content of PCT Patent Application Number PCT/US2021/018652, filed on Feb. 19, 2021, is hereby incorporated by reference.

PCT Patent Application Number PCT/US2021/018652, filed on Feb. 19, 2021, claims priority, under 35 U.S.C. §119(e), from US Provisional Patent Application Ser. No. 62/980,192, filed on Feb. 22, 2020.

The present application claims priority, under 35 U.S.C. §119(e), from US Provisional Patent Application, Ser. No. 62/980,192, filed on Feb. 22, 2020. The entire content of US Provisional Patent Application, Ser. No. 62/980,192, filed on Feb. 22, 2020, is hereby incorporated by reference.

### BACKGROUND

Current processes for printing on objects, such as buckets, are primarily pad printing or screen printing processes. Alternatively, in mold printing is an option.

All of these methods are time consuming with respect to setup and as a result are used for printing a large number of the same image. Minimum order quantities at a reasonable price can be in the 5000-10,000 range. Shorter runs can be done, but at a very high price due to the setup time.

In addition, color quality for pad and screen printing is limited, especially when trying to do full color continuous tone or process color printing.

Therefore, it is desirable to provide a printing process and system for printing on objects that can be setup quickly.

Also, it is desirable to provide a printing process and system for printing on objects that can be economically used for short runs.

Additionally, it is desirable to provide a printing process and system for printing on objects that can do full color continuous tone or process color printing.

Lastly, it is desirable to provide a printing process and system for printing on objects that can be setup quickly, be economically used for short runs, and do full color continuous tone or process color printing.

### BRIEF DESCRIPTION OF THE DRAWING

The drawings are only for purposes of illustrating various embodiments and are not to be construed as limiting, wherein:

FIG. 1 illustrates a printing station;

FIG. 2 illustrates a curing station;

FIG. 3 illustrates a pretreatment station;

FIG. 4 illustrates an outer view of a three stage printing system;

FIG. 5 illustrates an outer view of a two stage printing system;

FIG. 6 illustrates the internal view of the three stage printing system of FIG. 4; and

FIG. 7 illustrates the internal view of the three stage printing system of FIG. 5.

### DETAILED DESCRIPTION OF THE DRAWING

For a general understanding, reference is made to the drawings. In the drawings, like references have been used throughout to designate identical or equivalent elements. It is also noted that the drawings may not have been drawn to scale and that certain regions may have been purposely drawn disproportionately so that the features and concepts could be properly illustrated.

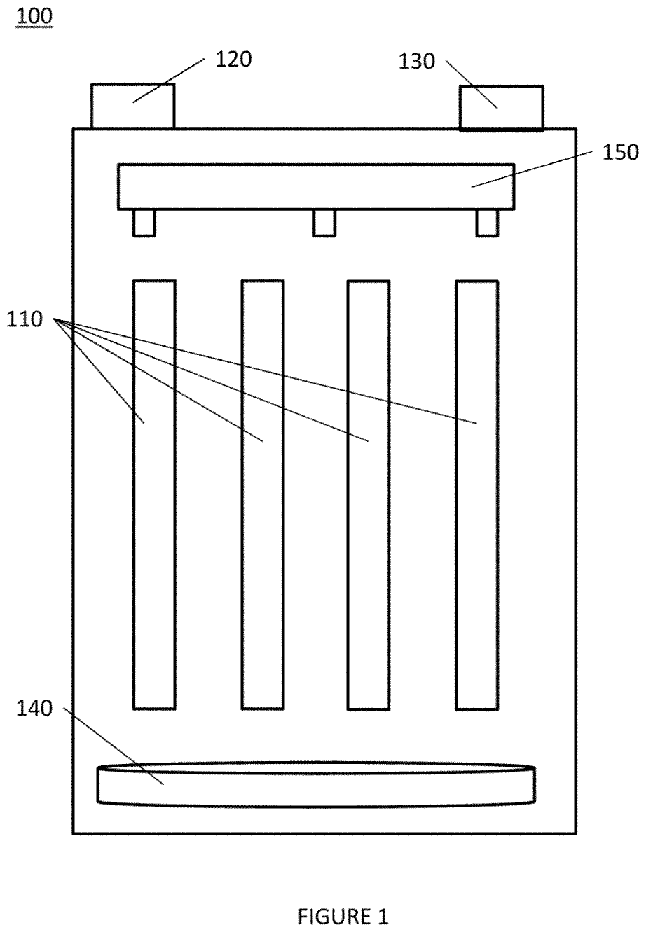

FIG. 1 illustrates a printing station 100. As illustrated in FIG. 1, the printing station 100 includes a plurality of vertically mounted print heads 110. The vertically mounted print heads 110 are mounted perpendicular to the ground with the print area shooting onto a rotating object with the axis of rotation pointing towards the ground.

As illustrated in FIG. 1, the plurality of vertically mounted print heads 110 may provide four different colors; however, the number of actually vertically mounted print heads 110 may vary based upon the desired operations. Also, the actual available number of colors may vary based upon the desired operations.

The printing station 100 may include a separate air intake system 120 and/or a separate exhaust system 130 to exchange air within the station without contaminating adjacent stations or the ambient environment.

The printing station 100 may include a rotating platform 140 to rotate an object to be printed. The rotating platform 140 may include an attachment mechanism (not shown) to secure the object to be printed upon to the rotating platform 140.

If the side of the object to be printed upon is not parallel to the shooting surface (area) of the vertically mounted print heads 110; i.e., the object to be printed upon has a tapered side, either the rotating platform 140 can be tilted so that the side of the object to be printed upon is parallel to the shooting surface (area) of the vertically mounted print heads 110, or the vertically mounted print heads 110 can be tilted so that the side of the object to be printed upon is parallel to the shooting surface (area) of the vertically mounted print heads 110. The tilting functionality allows the printing station 100 to print an image on a tapered surface or objects that have different tapers.

The printing station 100 may include a transport mechanism 150 to move an object to be printed upon to a position over the rotating platform 140 or to move a printed object out of the printing station 100. The transport mechanism 150 may include an attachment mechanism (not shown) to secure the object to the transport mechanism 150.

It is noted that the axis of rotation of the rotating object is parallel to the vertically mounted print heads 110. In contrast, horizontally mounted print heads would be perpendicular to the axis of rotation of a rotating object.

The vertical mounting of the plurality of print heads 110 enables the printing of an entire height of a rotating object. As illustrated in FIG. 1, the height of the rotating object being a direction orthogonal to the rotating platform 140, extending from the rotating platform 140 to the transport mechanism 150.

To compensate for the orientation of the print image on the object, the printing station 100 may include sensor(s) (not shown) to detect handles, fiducials, or other orienting features on the object. The detection of the handles, fiducials, or other orienting features assists the controller (not shown) of the printing station 100 to determine the orientation of the object so as to control the timing of the printing of the image upon the desired space on the object.

The printing station 100 may include an image processing subsystem (not shown) to modify the print image data to conform to the surface of the object to be printed. For example, it may be necessary to distort the image such that when the image is printed upon the surface of the object the image looks right on the surface. The image processing subsystem has the capability of scanning the object, creating a distortion pattern, and modifying the image to be printed based on the distortion pattern. This is also enables additional shapes such as square objects or other non-cylindrical objects.

The printing station 100 may include an image defect subsystem (not shown) to determine if the object has an image defect and possibly correct the imaging/printing process in accordance with the determined image defect. The image defect subsystem may detect missing jets, improper color, extraneous spots or marks, missing image, and/or other defects.

The printing station 100 may include a subsystem (not shown) that detects the surface of the object and adjusts the printing operation to the spacing between objects.

The printing station 100 is scalable for size of object, height, diameter, and shape. Print heads 110 can be added or subtracted or alignment changed to match various shapes including compound shapes.

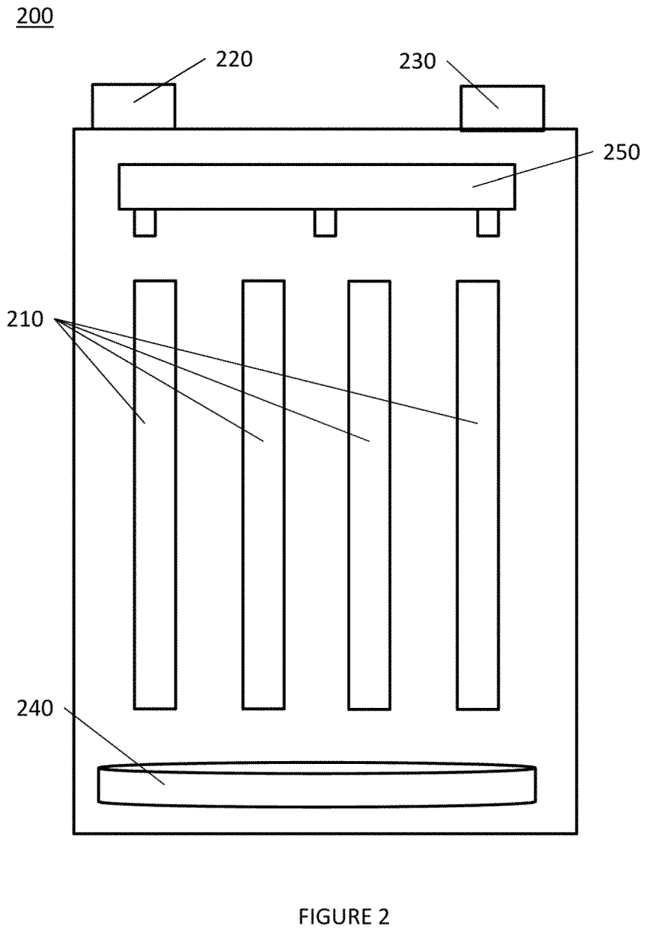

FIG. 2 illustrates a curing station 200. As illustrated in FIG. 2, the curing station 200 includes a plurality of curing (UV) lamps 210. The plurality of curing (UV) lamps 210 are used to cure the image printed by the printing station 100 on the object.

Although, as illustrated in FIG. 2, the curing (UV) lamps 210 are vertically mounted, the curing (UV) lamps 210 may be horizontally mounted.

The curing station 200 may include a separate air intake system 220 and/or a separate exhaust system 230 to exchange air within the station without contaminating adjacent stations or the ambient environment.

The curing station 200 may include a rotating platform 240 to rotate an object to be cured. The rotating platform 240 may include an attachment mechanism (not shown) to secure the object to be cured to the rotating platform 240.

If the side of the object to be cured is not parallel to the illumination surface (area) of the curing (UV) lamps 210; i.e., the object has a tapered side, either the rotating platform 240 can be tilted so that the side of the object to be cured is parallel to the illumination surface (area) of the curing (UV) lamps 210, or the curing (UV) lamps 210 can be tilted so that the side of the object to be cured is parallel to the illumination surface (area) of the curing (UV) lamps 210.

The curing station 200 may include a transport mechanism 250 to move an object to be cured to a position over the rotating platform 240 or to move a cured object out of the curing station 200. The transport mechanism 250 may include an attachment mechanism (not shown) to secure the object to the transport mechanism 250.

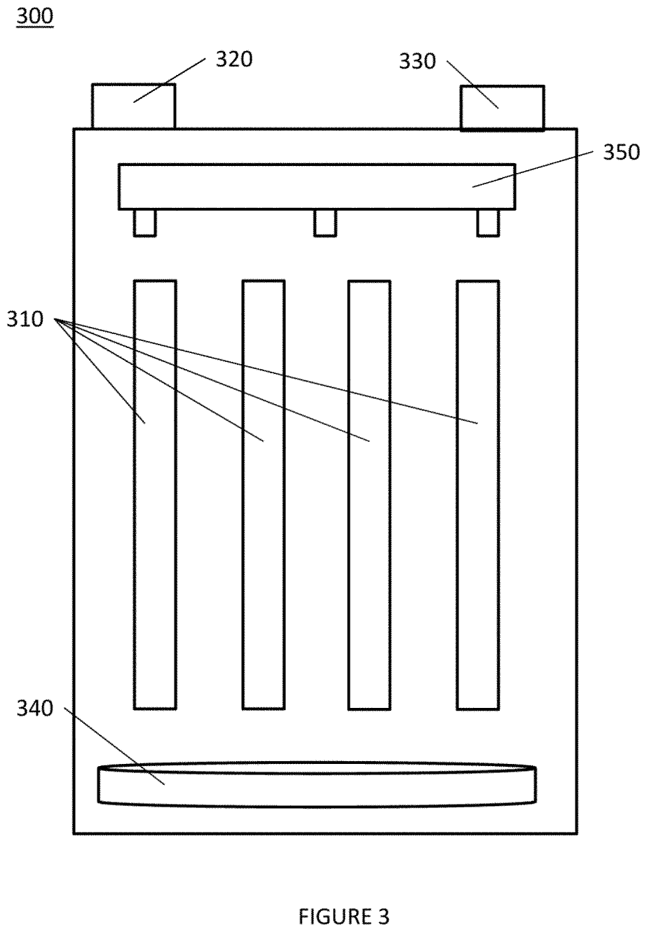

FIG. 3 illustrates a pretreatment station 300. As illustrated in FIG. 3, the pretreatment station 300 includes a plurality of burners or corona discharge devices 310. The plurality of burners or corona discharge devices 310 are used to pretreat the object to be printed.

Although, as illustrated in FIG. 3, the plurality of burners or corona discharge devices 310 are vertically mounted, the plurality of burners or corona discharge devices 310 may be horizontally mounted.

The pretreatment station 300 may include a separate air intake system 320 and/or a separate exhaust system 330 to exchange air within the station without contaminating adjacent stations or the ambient environment.

The pretreatment station 300 may include a rotating platform 340 to rotate an object to be printed. The rotating platform 340 may include an attachment mechanism (not shown) to secure the object to be printed to the rotating platform 340.

The pretreatment station 300 may include a transport mechanism 350 to move an object to be printed to a position over the rotating platform 340 or to move a pretreated object out of the pretreatment station 300. The transport mechanism 350 may include an attachment mechanism (not shown) to secure the object to the transport mechanism 350.

The pretreatment station 300 may include volatile organic compound sensors (not shown), especially for flame treatment, to assure that at no time will the air in the pretreatment station 300 be susceptible to rapid oxidation. In addition, the pretreatment station 300 may be maintained at a positive air pressure (air pressure greater than the ambient air pressure) to prevent volatile organic compounds from entering the flame area.

Furthermore, the pretreatment station 300 may include a separate ventilation system for filtering the air coming into the pretreatment station 300 and/or leaving the pretreatment station 300 to remove particulates and/or volatile organic compounds from the air such that the particulates and/or volatile organic compounds do not interfere with the pre-treatment process or contaminate the ambient air surrounding the printing system. It is noted that the pretreatment station 300 may have an air supply and/or exhaust system separate and/or independent of the air supply and/or exhaust systems for the printing station and/or curing station, described above.

It is noted that the printing station, described above, may include a separate ventilation system for filtering the air coming into the printing station and/or leaving the printing station to remove particulates and/or other non-desirable compounds (such as volatile organic compounds) from the air such that the particulates and/or other non-desirable compounds do not interfere with the printing process or contaminate the ambient air surrounding the printing system. Also, the printing station may have an air supply and/or exhaust system separate and/or independent of the air supply and/or exhaust systems for the pretreatment station and/or curing station, described above.

It is noted that the curing station, described above, may include a separate ventilation system for filtering the air coming into the curing station and/or leaving the curing station to remove particulates and/or other non-desirable compounds (such as volatile organic compounds) from the air such that the particulates and/or other non-desirable compounds do not interfere with the curing process or contaminate the ambient air surrounding the printing system. Also, the curing station may have an air supply and/or exhaust system separate and/or independent of the air supply and/or exhaust systems for the pretreatment station and/or printing station, described above.

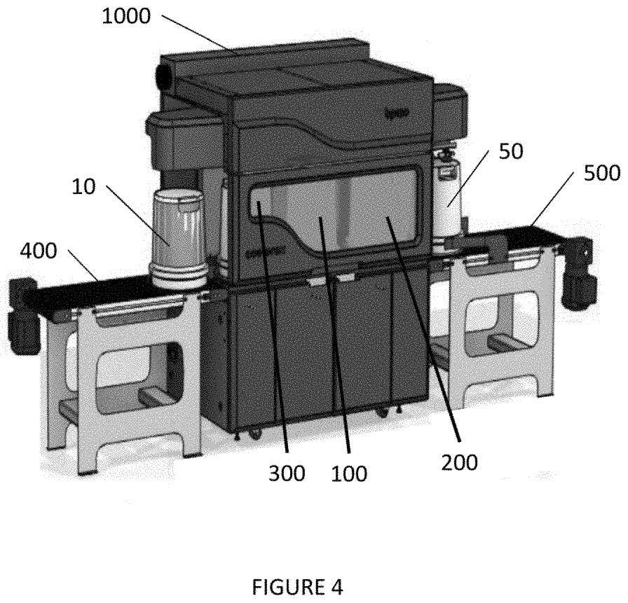

FIG. 4 illustrates a three stage printing system 1000 that includes a pretreatment station 300, a printing station 100, and a curing station 200. The three stage printing system 1000 may include an input conveyor system 400 to introduce an object (10) to be printed upon into the three stage printing system 1000. The three stage printing system 1000 may include an output conveyor system 500 to output a printed object (50) from the three stage printing system 1000.

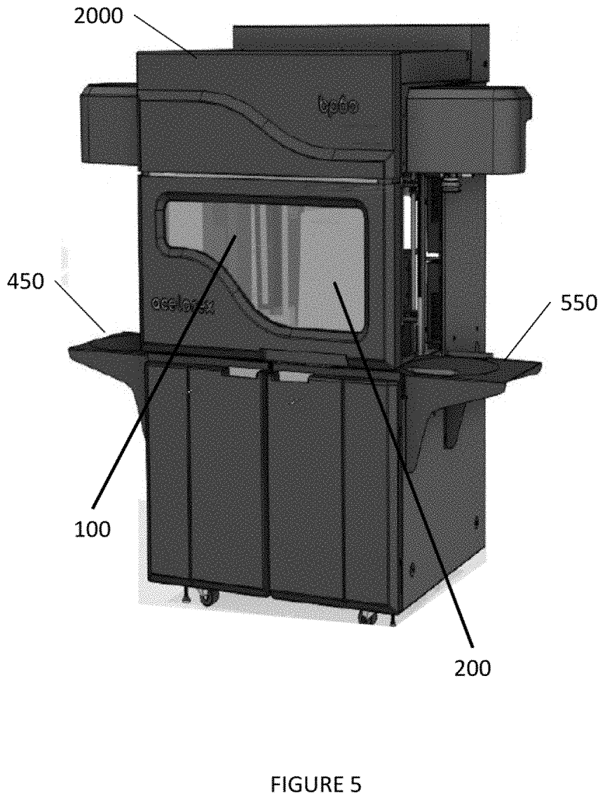

FIG. 5 illustrates a two stage printing system 2000 that includes a printing station 100 and a curing station 200. It is noted, that depending upon the required operations, the two stage printing system 2000 may include a printing station 100 and a pretreatment station 300.

The two stage printing system 2000 may include an input system 450 to introduce an object to be printed upon to the two stage printing system 2000. The two stage printing system 2000 may include an output system 550 to output a printed object from the two stage printing system 2000.

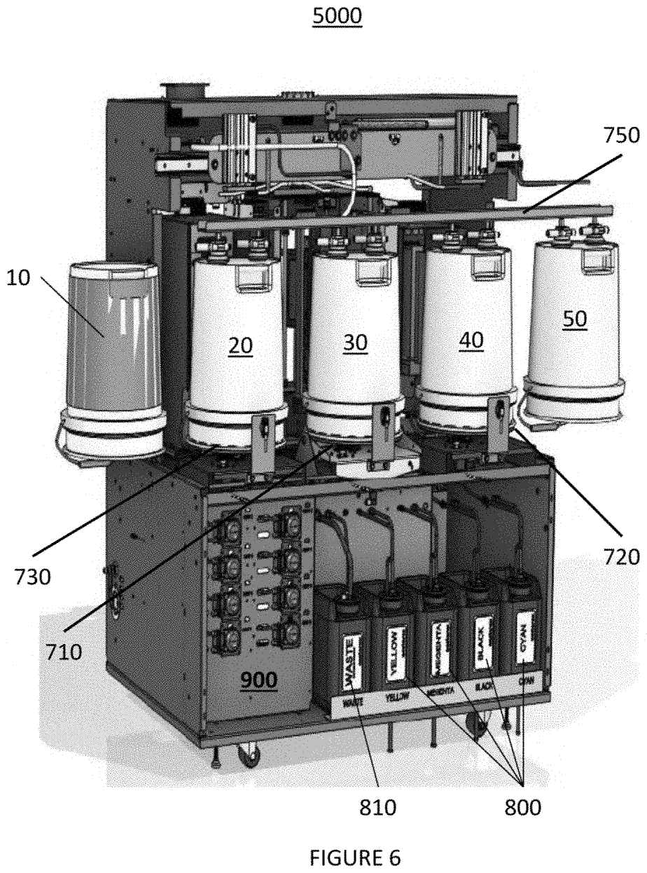

FIG. 6 illustrates the mechanics (in more detail) of a three stage printing system 5000. The three stage printing system 5000 includes an object 20 in a pretreatment station (such as pretreatment station 300 of FIG. 3), an object 30 in a printing station (such as printing station 100 of FIG. 1), and an object 40 in a curing station (such as curing station 200 of FIG. 2).

The three stage printing system 5000 also includes printing (marking) material containers 800 for storing the marking materials used in the printing process. The printing (marking) material containers 800 may be integrated containers that are re-fillable or the printing (marking) material containers 800 may be detachable and thus replaced with another container with printing (marking) material. The printing (marking) material containers 800 are operatively connected to the printing station through conduits.

In the embodiment of FIG. 6, the printing (marking) material containers 800 contain colored ink(s), which are transported to the printing station through conduits.

The three stage printing system 5000 further includes a printing (marking) material waste container 810 for collecting the waste printing (marking) materials used by the printing station. The printing (marking) material waste container 810 is operatively connected to the printing station through conduits.

Upon the completion of the printing process, the three stage printing system 5000 outputs a printed object 50.

The three stage printing system 5000 may include a separate air intake system and/or a separate exhaust system to exchange air within the three stage printing system 5000 without contaminating adjacent three stage printing systems or the ambient environment.

It is noted that, the pretreatment station may include a separate ventilation system for filtering the air coming into the pretreatment station and/or leaving the pretreatment station to remove particulates and/or volatile organic compounds from the air such that the particulates and/or volatile organic compounds do not interfere with the pre-treatment process or contaminate the ambient air surrounding the printing system. It is noted that the pretreatment station may have an air supply and/or exhaust system separate and/or independent of the air supply and/or exhaust systems for the printing station and/or curing station, described above.

It is further noted that the printing station, described above, may include a separate ventilation system for filtering the air coming into the printing station and/or leaving the printing station to remove particulates and/or other non-desirable compounds (such as volatile organic compounds) from the air such that the particulates and/or other non-desirable compounds do not interfere with the printing process or contaminate the ambient air surrounding the printing system. Also, the printing station may have an air supply and/or exhaust system separate and/or independent of the air supply and/or exhaust systems for the pretreatment station and/or curing station, described above.

It is also noted that the curing station, described above, may include a separate ventilation system for filtering the air coming into the curing station and/or leaving the curing station to remove particulates and/or other non-desirable compounds (such as volatile organic compounds) from the air such that the particulates and/or other non-desirable compounds do not interfere with the curing process or contaminate the ambient air surrounding the printing system. Also, the curing station may have an air supply and/or exhaust system separate and/or independent of the air supply and/or exhaust systems for the pretreatment station and/or printing station, described above.

The three stage printing system 5000, as illustrated in FIG. 6, may include a rotating platform 720 to rotate an object to be cured. The rotating platform 720 may include an attachment mechanism (not shown) to secure the object to be cured to the rotating platform 720.

If the side of the object to be cured is not parallel to the illumination surface (area) of the curing (UV) lamps; i.e., the object has a tapered side, either the rotating platform 720 can be tilted so that the side of the object to be cured is parallel to the illumination surface (area) of the curing (UV) lamps, or the curing (UV) lamps can be tilted so that the side of the object to be cured is parallel to the illumination surface (area) of the curing (UV) lamps.

The three stage printing system 5000, as illustrated in FIG. 6, may include a rotating platform 710 to rotate an object to be printed. The rotating platform 710 may include an attachment mechanism (not shown) to secure the object to be printed to the rotating platform 710.

If the side of the object to be printed upon is not parallel to the shooting surface (area) of the vertically mounted print heads; i.e., the object to be printed upon has a tapered side, either the rotating platform 710 can be tilted so that the side of the object to be printed upon is parallel to the shooting surface (area) of the vertically mounted print heads, or the vertically mounted print heads can be tilted so that the side of the object to be printed upon is parallel to the shooting surface (area) of the vertically mounted print heads. The tilting functionality allows the printing station to print an image on a tapered surface or objects that have different tapers.

To compensate for the orientation of the print image on the object, the printing station may include sensor(s) (not shown) to detect handles, fiducials, or other orienting features on the object. The detection of the handles, fiducials, or other orienting features assists the controller (not shown) of the printing station to determine the orientation of the object so as to control the timing of the printing of the image upon the desired space on the object.

The printing station may include an image processing subsystem (not shown) to modify the print image data to conform to the surface of the object to be printed. For example, it may be necessary to distort the image such that when the image is printed upon the surface of the object the image looks right on the surface. The image processing subsystem has the capability of scanning the object, creating a distortion pattern, and modifying the image to be printed based on the distortion pattern. This is also enables additional shapes such as square objects or other non-cylindrical objects.

The printing station may include an image defect subsystem (not shown) to determine if the object has an image defect and possibly correct the imaging/printing process in accordance with the determined image defect. The image defect subsystem may detect missing jets, improper color, extraneous spots or marks, missing image, and/or other defects.

The printing station may include a subsystem (not shown) that detects the surface of the object and adjusts the printing operation to the spacing between objects.

The printing station is scalable for size of object, height, diameter, and shape. Print heads can be added or subtracted or alignment changed to match various shapes including compound shapes.

The three stage printing system 5000, as illustrated in FIG. 6, may include a rotating platform 730 to rotate an object to be pretreated. The rotating platform 730 may include an attachment mechanism (not shown) to secure the object to be pretreated to the rotating platform 730.

The three stage printing system 5000, as illustrated in FIG. 6, may include a transport mechanism 750 to move an object to a position over a rotating platform or to move an object out of a station. The transport mechanism 750 may include an attachment mechanism (not shown) to secure the object to the transport mechanism 750.

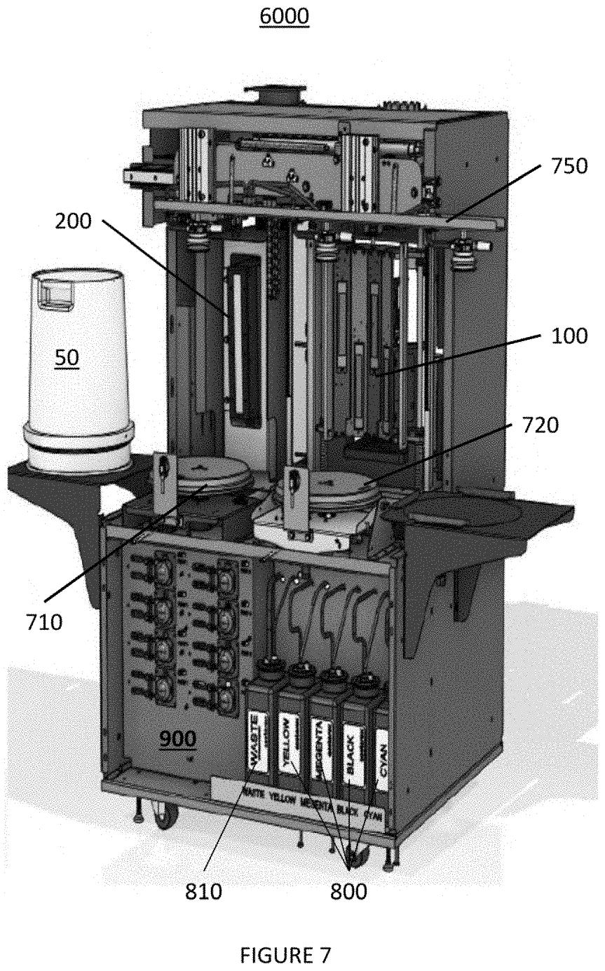

FIG. 7 illustrates the mechanics a two stage printing system 6000. The two stage printing system 6000 includes a printing station 100 and a curing station 200. It is noted, that depending upon the required operations, the two stage printing system 6000 may include a printing station and a pretreatment station.

The two stage printing system 6000 also includes printing (marking) material containers 800 for storing the marking materials used in the printing process. The printing (marking) material containers 800 may be integrated containers that are re-fillable or the printing (marking) material containers 800 may be detachable and thus replaced with another container with printing (marking) material. The printing (marking) material containers 800 are operatively connected to the printing station through conduits.

In the embodiment of FIG. 7, the printing (marking) material containers 800 contain colored ink(s), which are transported to the printing station through conduits.

The two stage printing system 6000 further includes a printing (marking) material waste container 810 for collecting the waste printing (marking) materials used by the printing station. The printing (marking) material waste container 810 is operatively connected to the printing station through conduits.

Upon the completion of the printing process, the two stage printing system 6000 outputs a printed object.

The two stage printing system 6000 may include a separate air intake system and/or a separate exhaust system to exchange air within the two stage printing system 6000 without contaminating adjacent three stage printing systems or the ambient environment.

It is noted that the printing station, described above, may include a separate ventilation system for filtering the air coming into the printing station and/or leaving the printing station to remove particulates and/or other non-desirable compounds (such as volatile organic compounds) from the air such that the particulates and/or other non-desirable compounds do not interfere with the printing process or contaminate the ambient air surrounding the printing system. Also, the printing station may have an air supply and/or exhaust system separate and/or independent of the air supply and/or exhaust systems for the pretreatment station and/or curing station, described above.

It is also noted that the curing station, described above, may include a separate ventilation system for filtering the air coming into the curing station and/or leaving the curing station to remove particulates and/or other non-desirable compounds (such as volatile organic compounds) from the air such that the particulates and/or other non-desirable compounds do not interfere with the curing process or contaminate the ambient air surrounding the printing system. Also, the curing station may have an air supply and/or exhaust system separate and/or independent of the air supply and/or exhaust systems for the pretreatment station and/or printing station, described above.

The two stage printing system 6000, as illustrated in FIG. 7, may include a rotating platform 710 to rotate an object to be cured. The rotating platform 710 may include an attachment mechanism (not shown) to secure the object to be cured to the rotating platform 710.

If the side of the object to be cured is not parallel to the illumination surface (area) of the curing (UV) lamps; i.e., the object has a tapered side, either the rotating platform 710 can be tilted so that the side of the object to be cured is parallel to the illumination surface (area) of the curing (UV) lamps, or the curing (UV) lamps can be tilted so that the side of the object to be cured is parallel to the illumination surface (area) of the curing (UV) lamps.

The two stage printing system 6000, as illustrated in FIG. 7, may include a rotating platform 720 to rotate an object to be printed. The rotating platform 720 may include an attachment mechanism (not shown) to secure the object to be printed to the rotating platform 720.

If the side of the object to be printed upon is not parallel to the shooting surface (area) of the vertically mounted print heads; i.e., the object to be printed upon has a tapered side, either the rotating platform 720 can be tilted so that the side of the object to be printed upon is parallel to the shooting surface (area) of the vertically mounted print heads, or the vertically mounted print heads can be tilted so that the side of the object to be printed upon is parallel to the shooting surface (area) of the vertically mounted print heads. The tilting functionality allows the printing station to print an image on a tapered surface or objects that have different tapers.

To compensate for the orientation of the print image on the object, the printing station may include sensor(s) (not shown) to detect handles, fiducials, or other orienting features on the object. The detection of the handles, fiducials, or other orienting features assists the controller (not shown) of the printing station to determine the orientation of the object so as to control the timing of the printing of the image upon the desired space on the object.

The printing station may include an image processing subsystem (not shown) to modify the print image data to conform to the surface of the object to be printed. For example, it may be necessary to distort the image such that when the image is printed upon the surface of the object the image looks right on the surface. The image processing subsystem has the capability of scanning the object, creating a distortion pattern, and modifying the image to be printed based on the distortion pattern. This is also enables additional shapes such as square objects or other non-cylindrical objects.

The printing station may include an image defect subsystem (not shown) to determine if the object has an image defect and possibly correct the imaging/printing process in accordance with the determined image defect. The image defect subsystem may detect missing jets, improper color, extraneous spots or marks, missing image, and/or other defects.

The printing station may include a subsystem (not shown) that detects the surface of the object and adjusts the printing operation to the spacing between objects.

The printing station is scalable for size of object, height, diameter, and shape. Print heads can be added or subtracted or alignment changed to match various shapes including compound shapes.

The two stage printing system 6000, as illustrated in FIG. 7, may include a transport mechanism 750 to move an object to a position over a rotating platform or to move an object out of a station. The transport mechanism 750 may include an attachment mechanism (not shown) to secure the object to the transport mechanism 750.

The printing process and system, as described above, may be an automated full color digital print system for on demand printing on cylindrical objects such as buckets, as well as square objects or other non-cylindrical objects.

Moreover, the printing process and system, as described above, may consist of robotic systems to acquire the object; i.e., a conveyor system; as well as to move the object from one station to another station.

The printing process and system, as described above, may pretreat the object with flame treatment, corona treatment, or other process as necessary.

Additionally, the printing process and system, as described above, may separate the curing station from the printing station to increase productivity and allow for flexibility in the curing process parameters such as time of exposure, power, etc.

It is noted that the architecture supports a pinning lamp in the print station if needed.

A staged printing system comprises a printing station for printing an image upon an object; and a curing station, operatively connected to the printing station, for curing the image printed upon the object; the printing station including a plurality of vertically mounted print heads for ejecting ink and a rotating platform for rotating the object as the plurality of vertically mounted print heads eject ink upon the object.

The staged printing system may further comprise an object transport mechanism for transporting the object from the printing station to the curing station.

The object transport mechanism may be configured to transport the object into the printing station. The object transport mechanism may be configured to transport the object out of the curing station.

The staged printing system may further comprise a pretreatment station for pretreating the object before printing an image upon the object.

The object transport mechanism may transport the object from the pretreatment stations to the printing station and from the printing station to the curing station. The object transport mechanism may be configured to transport the object into the pretreatment station. The object transport mechanism may be configured to transport the object out of the curing station.

The rotating platform may be configured to be tiltable such that a side of the object to be printed upon is parallel to an ejection surface of the plurality of vertically mounted print heads. The plurality of vertically mounted print heads may be configured to be tiltable such that a side of the object to be printed upon is parallel to an ejection surface of the plurality of vertically mounted print heads.

The printing station may include a printing station air supply and exhaust system for filtering particulates and volatile organic compounds from air entering the printing station and from air exiting the printing station. The curing station may include a curing station air supply and exhaust system for filtering particulates and volatile organic compounds from air entering the curing station and from air exiting the curing station system. The pretreatment station may include a pretreatment station air supply and exhaust system for filtering particulates and volatile organic compounds from air entering the pretreatment station and from air exiting the pretreatment station.

A staged printing system comprises a printing station for printing an image upon an object; and a pretreatment station, operatively connected to the printing station, for pretreating the object before printing an image upon the object; the printing station including a plurality of vertically mounted print heads for ejecting ink and a rotating platform for rotating the object as the plurality of vertically mounted print heads eject ink upon the object.

The staged printing system may further comprise an object transport mechanism for transporting the object from the printing station to the curing station.

The object transport mechanism may be configured to transport the object into the printing station. The object transport mechanism may be configured to transport the object out of the curing station.

The object transport mechanism may be configured to transport the object into the printing station. The object transport mechanism may be configured to transport the object out of the curing station.

The rotating platform may be configured to be tiltable such that a side of the object to be printed upon is parallel to an ejection surface of the plurality of vertically mounted print heads. The plurality of vertically mounted print heads may be configured to be tiltable such that a side of the object to be printed upon is parallel to an ejection surface of the plurality of vertically mounted print heads.

The printing station may include a printing station air supply and exhaust system for filtering particulates and volatile organic compounds from air entering the printing station and from air exiting the printing station. The pretreatment station may include a pretreatment station air supply and exhaust system for filtering particulates and volatile organic compounds from air entering the pretreatment station and from air exiting the pretreatment station.

It will be appreciated that variations of the above-disclosed embodiments and other features and functions, or alternatives thereof, may be desirably combined into many other different systems or applications. Also, various presently unforeseen or unanticipated alternatives, modifications, variations, or improvements therein may be subsequently made by those skilled in the art which are also intended to be encompassed by the description above.

What is claimed is:

1. A staged printing system comprising:
a printing station for printing an image upon an object; and
a curing station, operatively connected to said printing station, for curing the image printed upon the object;
said printing station including,
a plurality of vertically mounted print heads for ejecting ink, and
a rotating platform for rotating the object as the plurality of vertically mounted print heads eject ink upon the object.

2. The staged printing system, as claimed in claim 1, further comprising:
an object transport mechanism for transporting the object from said printing station to said curing station.

3. The staged printing system, as claimed in claim 2, wherein said object transport mechanism is configured to transport the object into said printing station.

4. The staged printing system, as claimed in claim 2, wherein said object transport mechanism is configured to transport the object out of said curing station.

5. The staged printing system, as claimed in claim 1, further comprising:
a pretreatment station for pretreating the object before printing an image upon the object.

6. The staged printing system, as claimed in claim 5, further comprising:
an object transport mechanism for transporting the object from said pretreatment stations to said printing station and from said printing station to said curing station.

7. The staged printing system, as claimed in claim 6, wherein said object transport mechanism is configured to transport the object into said pretreatment station.

8. The staged printing system, as claimed in claim 6, wherein said object transport mechanism is configured to transport the object out of said curing station.

9. The staged printing system, as claimed in claim 1, wherein said rotating platform is configured to be tiltable such that a side of the object to be printed upon is parallel to an ejection surface of said plurality of vertically mounted print heads.

10. The staged printing system, as claimed in claim 1, wherein said plurality of vertically mounted print heads is configured to be tiltable such that a side of the object to be printed upon is parallel to an ejection surface of said plurality of vertically mounted print heads.

11. The staged printing system, as claimed in claim 1, wherein said printing station includes a printing station air supply and exhaust system for filtering particulates and volatile organic compounds from air entering said printing station and from air exiting said printing station.

12. The staged printing system, as claimed in claim 1, wherein said curing station includes a curing station air supply and exhaust system for filtering particulates and volatile organic compounds from air entering said curing station and from air exiting said curing station system.

13. The staged printing system, as claimed in claim 12, wherein said printing station includes a printing station air supply and exhaust system for filtering particulates and volatile organic compounds from air entering said printing station and from air exiting said printing station.

14. The staged printing system, as claimed in claim 5, wherein said printing station includes a printing station air supply and exhaust system for filtering particulates and volatile organic compounds from air entering said printing station and from air exiting said printing station.

15. The staged printing system, as claimed in claim 14, wherein said curing station includes a curing station air supply and exhaust system for filtering particulates and volatile organic compounds from air entering said curing station and from air exiting said curing station system.

16. The staged printing system, as claimed in claim 15, wherein said pretreatment station includes a pretreatment station air supply and exhaust system for filtering particulates and volatile organic compounds from air entering said pretreatment station and from air exiting said pretreatment station.

17. A staged printing system comprising:
a printing station for printing an image upon an object; and
a pretreatment station, operatively connected to said printing station, for pretreating the object before printing an image upon the object;
said printing station including,
a plurality of vertically mounted print heads for ejecting ink, and
a rotating platform for rotating the object as the plurality of vertically mounted print heads eject ink upon the object.

18. The staged printing system, as claimed in claim 17, further comprising:
an object transport mechanism for transporting the object from said pretreatment station to said printing station.

19. The staged printing system, as claimed in claim 18, wherein said object transport mechanism is configured to transport the object into said pretreatment station.

20. The staged printing system, as claimed in claim 18, wherein said object transport mechanism is configured to transport the object out of said printing station.

21. The staged printing system, as claimed in claim 17, wherein said rotating platform is configured to be tiltable such that a side of the object to be printed upon is parallel to an ejection surface of said plurality of vertically mounted print heads.

22. The staged printing system, as claimed in claim 17, wherein said plurality of vertically mounted print heads is configured to be tiltable such that a side of the object to be printed upon is parallel to an ejection surface of said plurality of vertically mounted print heads.

23. The staged printing system, as claimed in claim 17, wherein said printing station includes a printing station air supply and exhaust system for filtering particulates and volatile organic compounds from air entering said printing station and from air exiting said printing station.

24. The staged printing system, as claimed in claim 17, wherein said pretreatment station includes a pretreatment station air supply and exhaust system for filtering particulates and volatile organic compounds from air entering said pretreatment station and from air exiting said pretreatment station system.

25. The staged printing system, as claimed in claim 24, wherein said printing station includes a printing station air supply and exhaust system for filtering particulates and volatile organic compounds from air entering said printing station and from air exiting said printing station.
